(19) United States
(12) Patent Application Publication
(10) Pub. No.: US 2017/0134901 A1
(43) Pub. Date: May 11, 2017

(54) ACTIVITY SHARING SOCIAL MEDIA PLATFORM AND METHODS THEREOF

(71) Applicants: C. Devrim Uyanik, Santa Monica, CA (US); Emre Ipek, Santa Monica, CA (US)

(72) Inventors: C. Devrim Uyanik, Santa Monica, CA (US); Emre Ipek, Santa Monica, CA (US)

(21) Appl. No.: 15/347,692

(22) Filed: Nov. 9, 2016

Related U.S. Application Data
(60) Provisional application No. 62/252,739, filed on Nov. 9, 2015.

(51) Int. Cl. H04W 4/02; H04L 29/08

(52) U.S. Cl. CPC H04W 4/023; H04L 67/10; H04W 4/027

(57) ABSTRACT

The present disclosure generally relates to a social media platform for matching people with mutual interest. In one embodiment of the present disclosure, social media platform comprises: a mobile application or a mobile electronic device that allows a user to provide a description of an activity that requires at least two people to participate; an electronic sever that receives the description of an activity and transmits the activity to people who are seeking to join similar activity, people who show interest in the activity or people who are close to the user; wherein the electronic server establishes a communication between the user with the people who are seeking to join similar activity, people who show interest in the activity or people who are close to the user.

### CROSS-REFERENCE TO RELATED PATENT APPLICATIONS

Embodiments of the present invention relate to U.S. Provisional Application Ser. No. 62/252,739, filed Nov. 9, 2015, entitled “ACTIVITY SHARING SOCIAL MEDIA PLATFORM AND METHODS THEREOF”, the contents of which are incorporated by reference herein in their entirety and which are basis for the claim of priority.

### FIELD OF THE INVENTION

Embodiments of the present disclosure generally relate to a social media platform and more specifically to a platform that allows users to interact, meet and share their interests and activities with each other.

### SUMMARY OF THE DISCLOSURE

The major objective of the present disclosure is to provide a platform that allows people to interact, meet and share their mutual interests and activities by offering each other anything they would like to share. The activity (or event) owner will provide offers (or activities) with or without a fee. While using the platform's mobile or computer application, people will be able to share pictures or videos of their self s and what they are offering to others. They will be able to see other offers by looking nearby offers. Making new friends, adding them to their profile like social networking application. The disclosed platform differs from conventional social networking applications by providing a real social interact. Users of the platform can join in any plan easier than any other conventional applications. The targeted group varies and it is worldwide. Age range is very wide from teenagers to adults as well as gender.

In accordance with one aspect of at least one embodiment of the present disclosure, the platform comprises: a mobile application or a mobile electronic device that allows a user to provide a description of an activity that requires at least two people to participate; an electronic sever that receives the description of an activity and transmits the activity to people who are seeking to join similar activity, people who show interest in the activity or people who are close to the user; wherein the electronic server establishes a communication between the user with the people who are seeking to join similar activity, people who show interest in the activity or people who are close to the user.

Among other things, the disclosed platform allows a person to invite other people to watch a movie for free; to create a nightlife event and invite people to their table for free, to invite people to drive to another state, city or any place to create a road trip even; to create an event for concert and invite people; to create a surf event and invite people; to create a study panel or find a studying partner during midterm or final period if the person does not want to study alone; to create a sporting activity such as basketball teams, finding a tennis partner and invite people; to create a weekend activities to hang out and meet with new group of people etc.

With the assistance of the disclosed platform, people will never feel alone and stay without any plan. They can create any event about what they want to do and invite other people to join in. Exploring new places will be easier than ever with the disclosed platform. In addition, companies can also utilize the disclosed platform to create public or private event.

The foregoing and other objects, features and advantages of the present invention are more readily apparent from the detailed description of the preferred embodiments set forth below, taken in conjunction with the accompanying drawings.

### DETAILED DESCRIPTION OF PREFERRED EMBODIMENTS

The following description is not to be taken in a limiting sense, but is made merely for the purpose of illustrating the general principles of the invention, since the scope of the invention is best defined by the following claims. Various inventive features are described below that can each be used independently of one another or in combination with other features.

Broadly, embodiments of the present disclosure generally provide a social media platform that comprises a mobile application or a mobile electronic device that allows a user to provide a description of an activity (or an offer or event) that requires at least two people to participate; and an electronic sever that receives the description of the activity and transmits the activity to other users of the platform who are seeking to join similar activity, who show interest in the activity or who are close to the user.

In accordance with one aspect of at least one embodiment of the present disclosure, the disclosed platform comprises a non-transitory computer-readable storage medium comprising programmable instructions (e.g., a software or mobile application) adapted to be executed on one or more processors (e.g., on a mobile device or computer), and to perform a method of: allowing users to register and create their personal profiles on a computer server through an application interface via a mobile device or computer; allowing a first user to create an activity (or an event) that requires at least two people to participate and provide description for the activity on the computer server via the application interface, wherein the first user defines at least title, date, time, location, category and maximum number of participants for the activity; allowing the first user to invite a specific group of users or individuals designated by the first user to join the activity (e.g., such as creating a private activity), or open the activity to public through the application interface; allowing a second user to see the activity if the second user is invited by the first user, or to search for the activity if the activity is open to the public through the application interface; allowing the second user to view the first user's personal profile and rating through the application interface; allowing the first user and the second user to exchange communication regarding the activity through the application interface (e.g., phone, text or email etc.); and allowing the second user to join the activity if maximum number of participants for the activity has not been reached or to send a join request to the first user if it is required, where the first user will receive a notice from the computer server regarding whether the second user is participating the activity. The first user or anyone who can see the activity will be able to view a list of people who have decided to participate the activity.

The personal profile created by a user includes at least the user's name, gender, date of birth and photo. Users of the platform will be able to view each other's profile, and to follow with each other like conventional social network applications (e.g., Facebook® and Twitter®). A user may also choose who can view his or her profile in the privacy setting so that only the user's friend or people who have followed or authorized by the user can view the user's profile. Similarly, the user may designate an activity created to be a private activity and only users who have followed or authorized by the user can search or see the activity posted by the user. In creating the person profile, the user will be asked to provide his or her email and set up a password for future logins. Alternatively, the user can log into the disclosed platform using accounts from existing social network (e.g., Facebook® or Gmail® account) and the user may incorporate his or her profile from existing social network as well. The user can also sync his or her contacts in his or her mobile phone with the disclosed platform, and/or incorporate the contacts from the existing social network.

When a user is searching for an activity hosted by other users, the user can filter his or her search at least based on the activity's category or distance from the user. Other type of filter may also be used. For example, the user may also search for available activities based on activity owner's gender, age range and rating etc.

In creating an activity, if the activity requires a fee, the user who creates the activity can specify who will pay the fee. For example, the activity creator can choose that he or she will pay the entire fee, the participants will pay the entire fee, or the fee will split among the participant(s) and the activity creator (or without activity creator) in a specified portion. If the activity is periodically available or is ongoing, or if the activity creator creates a lot of activities, the activity creator can provide a package which specifies how many activities within the event are free to the participants and how many activities require fees. For example, a tennis coach who wants to promote or advertise his or her coaching service may create multiple tennis activities and specify that first three tennis activities are free for any participants but the participants will need to pay certain fee starting from the fourth tennis activity. This allows a tennis coach to effectively promote his or her coaching service and possibly make money if participants decide to continue participating the tennis activities.

Users of the platform will be able to rate each other and the activities, and provide comments to the activities. If a user finds that an activity posted is inappropriate or is a spam, the user may report this to a system administrator. If the system administrator determines that the report is accurate, the activity will be removed from the platform and the user who posted the activity may receive a warning or be banned from posting any further activities.

In addition, the platform also allows a user to block other users so that the user will not receive any invitations to activities from blocked users. When the user performs search for available activities, activities created by blocked users will not show up on the user's search result as well. The user may choose to unblock the blocked user(s) anytime the user desires.

In one embodiment of the present disclosure, in creating the activity, the first user may post photo or video or both to describe the activity and to make the activity to look more attractive. The user and the participants of the activity may also upload and post photo and video of the activity during or after the activity and share them with other participants or their friends. People who showed in the photo or video can be tagged or untagged so that they know their photos have been posted by someone else. People who can see the photo or video can also make comments to the photo and the video. If a user or participant finds a posted photo or video is inappropriate, the user may report the issue to the system administrator and ask the system administer or the poster to remove the inappropriate photo or video.

In yet another embodiment of the present disclosure, once a user discovers an activity he or she has interested in participating, the user will be able to send request to activity creator/owner (i.e., the first user). If activity owner accepts the request, a communication channel will be established between them and they will be able to chat. During the chat, users will be able to share pictures, videos and/or voice record with each other. Length of video can be set to a specific length to prevent excessive data usage, such as only allowing 10 sec videos to be transmitted.

In yet another embodiment of the present disclosure, the disclosed social media platform allows user to share pictures or videos of their self's and what they are offering (the activity or event) to others. They will be able to see other offers by looking nearby offers, or searching for offers that match their interests. For instance, the social media platform allows the user to search its database for activities or events that match input or query provided by the user.

In yet another embodiment of the present disclosure, the mobile application of the disclosed platform is configured in a way that it allows the user to add events with description by clicking to add event in the mobile application and share to public or to designated group of people. Users will be able to see other events nearby or events they are interested in (provided that they have preset their interest preference). Companies can create public or private events using the platform of the present disclosure.

In yet another embodiment of the present disclosure, all the events joined/participated by a user is being recorded at a database. Thus, the user can see past events and his or her pictures etc. Also users can send new event requests to previous event owners or other followers.

In yet another embodiment of the present disclosure, each user has its own profile page where the user can always check and modify his or her profile to make others to know them better. They also have the option of following activities or event created by a specific person or group.

In yet another embodiment of the present disclosure, the disclosed platform comprises a non-transitory computer-readable storage medium comprising programmable instructions adapted to be executed on one or more computer server(s), and to perform a method of: receiving registration information from users; creating and displaying users' personal profiles on an application interface that runs on a mobile device or computer, wherein the users' personal profiles include at least users' name, gender, date of birth and photo; receiving description of an activity that requires at least two people to participate from a first user, wherein the description of the activity includes title, date, time, location, category and maximum number of participants; storing users' personal profiles and the description of the activity on a computer server or database; transmitting and displaying the description of the activity to a specific group of users or individuals designated by the first user or to the public if authorized by the first user via the application interface, if the activity is opened to the public, the description of activity will only be transmitted and displayed to users who have not blocked the first user or users who have provide search on the computer server and the search criteria matches the activity; establishing communication between the first user with users who are seeking to join the activity, users who show interest in the activity or users who are in proximity to the first user; displaying a list of the activity's participants upon receiving request from the first user or users who can see the activity; notifying the first user whenever a user decides or refuses to join the activity; and receiving rating from users with regards to the first user or the activity or both and display the rating to other user when the first user's personal profile or the activity is being viewed by the other user. Similarly, the platform allows users to submit report with regards to whether an activity is appropriate or is a spam and transmitting the report to an administrator.

Among other things, the disclosed social media platform allows people interact, meet and share their mutual interests and activities by offering each other anything they would like to share. The activity or event creator has the option of allowing others to join the created activity or event for free or for a fee. For example and not by way of limitation, activity or event may include inviting a person to watch a movie, creating a nightlife event and invite people to their table, creating an event for concert and invite people, inviting people to join a surf event, creating a study panel to invite people to study together or provide tutorial, creating a sport event and invite people to join, creating a weekend activities to hang out and meet with new group of people, creating an event inviting people to explore new places and creating a house event and inviting people to join.

The foregoing and other objects, features and advantages of the present invention are more readily apparent from the detailed description of the preferred embodiments set forth below, taken in conjunction with the accompanying drawings.

What is claimed is:

1. A non-transitory computer-readable storage medium comprising programmable instructions adapted to be executed on one or more processors, and to perform a method of:
allowing users to register and create their personal profiles on a computer server through an application interface via a mobile device or computer;
allowing a first user to create an activity that requires at least two people to participate and provide description for the activity on the computer server via the application interface, wherein the first user defines at least title, date, time, location, category and maximum number of participants for the activity;
allowing the first user to specify how the activity's fee will be split among the first user and the users who want to participate the activity if the activity requires a fee;
allowing the first user to invite a specific group of users or individuals designated by the first user to join the activity, or open the activity to public through the application interface;
allowing a second user to see the activity if the second user is invited by the first user, or to search for the activity if the activity is open to the public through the application interface;
allowing the second user to view the first user's personal profile and rating through the application interface;
allowing the first user and the second user to exchange communication regarding the activity through the application interface; and
allowing the second user to join the activity if maximum number of participants for the activity has not been reached or to send a join request to the first user if it is required, where the first user will receive a notice from the computer server regarding whether the second user is participating the activity.

2. The computer-readable medium of claim 1, wherein the personal profiles include at least users' name, gender, date of birth and photo.

3. The computer-readable medium of claim 1, wherein the second user search for the activity based on the activity's category or distance from the second user or both.

4. The computer-readable medium of claim 1 further comprises:
allowing the second user to rate the first user or the activity or both.

5. The computer-readable medium of claim 1 further comprises:
allowing the second user to block first user from sending any invitation to an activity in the future or to stop seeing any activity posted by the first user.

6. The computer-readable medium of claim 1 further comprises:
allowing the first user to post photo or video or both for the activity.

7. The computer-readable medium of claim 1 further comprises:
allowing the first user and the second user to view a list of people who have decided to participate the activity.

8. The computer-readable medium of claim 1 further comprises:
allowing the second user to report to an administrator regarding the appropriateness of the activity or whether an activity is a spam.

9. The computer-readable medium of claim 1, wherein the activity can be searched by the second user only if the second user follows the first user.

10. The computer-readable medium of claim 1, wherein the specific group of users or individuals designated by the first user are contacts incorporated from the first user's existing social network site.

11. The computer-readable medium of claim 1, wherein the firs user and the second user exchange communication through texting.

12. The computer-readable medium of claim 1, wherein the activity includes watching a movie, creating a nightlife event, creating an event for concert, creating a surf event, creating a study panel, creating a sport event and creating a weekend activities.

13. A non-transitory computer-readable storage medium comprising programmable instructions adapted to be executed on one or more processors, and to perform a method of:
allowing users to register and create their personal profiles on a computer server through an application interface via a mobile device or computer, wherein the personal profiles include at least users' name, gender, date of birth and photo;
allowing a first user to create an activity that requires at least two people to participate and provide description for the activity on the computer server via the application interface, wherein the first user defines at least title, date, time, location, category and maximum number of participants for the activity;
allowing the first user to specify how the activity's fee will be split among the first user and the users who want to participate the activity if the activity requires a fee;
allowing the first user to invite a specific group of users or individuals designated by the first user to join the activity, or open the activity to public through the application interface;
allowing a second user to see the activity if the second user is invited by the first user, or to search for the activity if the activity is open to the public through the application interface, wherein the second user search for the activity based on the activity's category or distance from the second user or both;
allowing the second user to view the first user's personal profile and rating through the application interface;
allowing the first user and the second user to exchange communication regarding the activity through the application interface;
allowing the second user to report to an administrator regarding the appropriateness of the activity or whether an activity is a spam;
allowing the first user and the second user to view a list of people who have decided to participate the activity;
allowing the second user to join the activity if maximum number of participants for the activity has not been reached or to send a join request to the first user if it is required, where the first user will receive a notice from the computer server regarding whether the second user is participating the activity; and
allowing the second user to rate the first user or the activity or both.

14. The computer-readable medium of claim 13 further comprises:
allowing the second user to block first user from sending any invitation to an activity in the future or to stop seeing any activity posted by the first user.

15. The computer-readable medium of claim 13 further comprises:
allowing the first user to post photo or video or both for the activity.

16. A non-transitory computer-readable storage medium comprising programmable instructions adapted to be executed on one or more processors, and to perform a method of:
receiving registration information from users;
creating and displaying users' personal profiles on an application interface that runs on a mobile device or computer, wherein the users' personal profiles include at least users' name, gender, date of birth and photo;
receiving description of an activity that requires at least two people to participate from a first user, wherein the description of the activity includes title, date, time, location, category and maximum number of participants;
storing users' personal profiles and the description of the activity on a computer server or database;
transmitting and displaying the description of the activity to a specific group of users or individuals designated by the first user or to the public if authorized by the first user via the application interface, if the activity is opened to the public, the description of activity will only be transmitted and displayed to users who have not blocked the first user or users who have provide search on the computer server and the search criteria matches the activity;
establishing communication between the first user with users who are seeking to join the activity, users who show interest in the activity or users who are in proximity to the first user;
displaying a list of the activity's participants upon receiving request from the first user or users who can see the activity;
notifying the first user whenever a user decides or refuses to join the activity; and
receiving rating from users with regards to the first user or the activity or both and display the rating to other user when the first user's personal profile or the activity is being viewed by the other user.

17. The computer-readable medium of claim 16 further comprises:
receiving report from users regarding the appropriateness of the activity or whether the activity is a spam and transmitting the report to an administrator.

18. The computer-readable medium of claim 16 further comprises:
receiving and displaying photo or video or both regarding the activity from the first user.

19. The computer-readable medium of claim 16, wherein the search criteria includes at least the activity's category and distance from the user who performs the search.

20. The computer-readable medium of claim 16, wherein the activity includes inviting a person to watch a movie, creating a nightlife event and invite people to their table, creating an event for concert and invite people, inviting people to join a surf event, creating a study panel to invite people to study together or provide tutorial, creating a sport event and invite people to join, creating a weekend activities to hang out and meet with new group of people, creating an event inviting people to explore new places and creating a house event and inviting people to join.
